(19) United States
(12) Patent Application Publication
(10) Pub. No.: US 2007/0096558 A1
(43) Pub. Date: May 3, 2007

(54) Enclosure track

(76) Inventor: Christopher J. Costa, Egg Harbor, NJ (US)

Correspondence Address: Hollstein Keating Cattell Johnson & Goldstein P.C.;Willow Ridge Executive Office Park, Suite 301, 750 Route 73 South, Marlton, NJ, 08053, US

(21) Appl. No.: 11/265,318

(22) Filed: Nov. 2, 2005

(51) Int. Cl. B60S 1/62

(52) U.S. Cl. 305/116

(57) ABSTRACT

An enclosure track has an elongated, longitudinally extending unitary body made of high strength, non-deformable, rigid material. The track has an upper section with a longitudinally extending space and a lower section with a longitudinally extending space which is contiguous with the space of the upper section. The track has a bottom wall with a curvilinear lower surface adapted to be mounted on surfaces of any radius, to maintain the track in place. At all times, and especially when connected to the top surface of a bulkhead or other supporting surface, the track, being non-deformable, maintains its original shape. Thus, the track's high strength and non-deformable configuration and construction eliminates bending or flexing of the track and permits it to successfully maintain any type of protective enclosure rigidly and securely in place.

### BACKGROUND OF THE INVENTION

Removable covers, canopies, shelters and similar protective enclosures are commonly used for many purposes, not the least of which include protecting the interior spaces of vehicles and marine vessels from the weather. Such enclosures, which include covers and tops made of canvas or other heavy-duty material, are also used to protect the cabs of industrial equipment and exterior living spaces such as residential patios and outdoor restaurants. Examples of the use of such enclosures on vessels and vehicle cabs are shown in U.S. Pat. No. 5,121,703.

Such enclosures have, in the past, been secured to their bases or supporting surfaces by a variety of different means e.g. buttons, snaps, Velcro®, twist fasteners, lashing, etc. There have been some attempts to secure the lower regions of enclosures within channel members. So far, these attempts have met with limited success. For example, FIG. 1 shows an existing channel with an outwardly extending flange connection. This arrangement is not adaptable to be connected to many types of surfaces and further, fails to provide a stable support. There is also increases in the cost of manufacturing this type of channel, especially since it requires the use of additional material. U.S. Pat. No. 4,903,629 discloses a boat slide channel assembly which is easily bendable and, in fact, is designed to deform substantially upon being secured to a surface. The configuration of this channel assembly and its deformable characteristics do not allow it to rigidly maintain enclosures in position, especially when such enclosures are subject to the elements of nature, like high wind conditions. The insubstantial configuration and construction of this type of channel also makes it very susceptible to failure due to breakage and long term exposure to the elements. It is, in large part, for these reasons that the assembly has not found any acceptance in the industry.

### SUMMARY OF THE INVENTION

It is therefore the object of the present invention to provide an enclosure track which overcomes the disadvantages and limitations of prior enclosure track support assemblies.

It is an object of the present invention to provide an enclosure track which is high strength, rigid, and non-deformable, even after assembly onto a support surface.

It is a further object of the present invention to provide an enclosure track which readily receives and rigidly maintains a protective enclosure in position on a support surface.

It is another object of the present invention to provide an enclosure track which is of a configuration which permits its placement and use on surfaces of various radii and which attaches easily to these surfaces without bending or otherwise deforming.

It is still another object of the present invention to provide an enclosure track which has a contoured curvilinear bottom surface to allow mounting on windshields, railings, tubing, and other curvilinear surfaces.

It is another object of the present invention to provide an enclosure track which allows the lip of an enclosure to slide unimpeded and unobstructed through the track, permitting the smooth and easy insertion and removal of the enclosure from the track.

It is a further object of the present invention to provide an enclosure track which can support a variety of protective enclosures for marine, vehicle and shoreside use.

It is an object of the present invention to provide an enclosure track which can be used on marine vessels, land-based industrial equipment vehicles, and outdoor living spaces such as outdoor restaurants and residential patios.

It is another object of the present invention to provide an enclosure track which can withstand the elements of nature, is durable, and can withstand repeated uses without failure.

These and other objects are accomplished by the present invention, an enclosure track which comprises an elongated longitudinally extending unitary body made of high strength, non-deformable, rigid material. The track has an upper section with a longitudinally extending space and a lower section with a longitudinally extending space which is contiguous with the space of the upper section. The track has a bottom wall with a curvilinear lower surface adapted to be mounted on surfaces of any radius, to maintain the track in place. At all times, and especially when connected to the top surface of a bulkhead or other supporting surface, the track, being non-deformable, maintains its original shape. Thus, the track's high strength and non-deformable configuration and construction eliminates bending or flexing of the track and permits it to successfully maintain any type of protective enclosure rigidly and securely in place.

Novel features which are considered as characteristic of the invention are set forth in particular in the appended claims. The invention, itself, however, both as to its design, construction and use, together with the additional features and advantages thereof, are best understood upon review of the following detailed description with reference to the accompanying drawings.

### BRIEF DESCRIPTION OF THE DRAWINGS

FIG. 1 is a partial isometric view of prior art.

FIG. 2 is a partial isometric view showing the enclosure track of the present invention.

FIG. 3 is an end view of the enclosure track of the present invention.

FIG. 4 is a partial side view of the enclosure track of the present invention.

FIG. 5 is a top view of the enclosure track of the present invention.

FIG. 6 is a bottom view of the enclosure track of the present invention.

FIG. 7 is a partial isometric view of the enclosure track of the present invention mounted on a support bulkhead, with a section of an enclosure located within the track.

### DETAILED DESCRIPTION OF THE DRAWINGS

Track 1 of the present invention comprises an elongated, longitudinally extending unitary body, preferably made of a high strength, non-deformable material, e.g. rigid PVC, hard plastic, or equivalent material. The rigid material from which the track is manufactured must, at all times, be able to maintain the shape of the track, even upon installation, as more fully described below.

Track 1 comprises upper section 2 having longitudinally extending space 4 partially surrounded by curvilinear interior surface 6. Track 1 further comprises lower section 8 having longitudinally extending space 10 which is contiguous with longitudinally extending space 4 of upper section 2. Side walls 11 and 12 of track 1 extend to form longitudinally extending slot 13 which opens into space 4.

The lower region of track 1 consists of bottom wall 14 which has a top surface 16 and a curvilinear bottom surface 18. Side walls 11 and 12 extend upwards from bottom surface 18 of bottom wall 14, to slot 13. Counter-sunk holes extend through bottom wall 14 and are configured to accept and seat a number of screws 22.

Bottom surface 18 of track 1 is configured to be positioned on top surface 32 of an upstanding bulkhead or wall 30 of a boat cabin, industrial vehicle side wall, or a living space such as an outdoor restaurant or residential patios. Once placed on top surface 32 of bulkhead 30, track 1 is secured to the bulkhead by means of a plurality of screws, represented in the accompanying drawings by screw 22. When fully tightened, screws 22 are located solely within space 10, through bottom wall 14 and into bulkhead 30.

The non-deformable, rigid nature of track 1 ensures that it will always maintain its shape, even after screws 22 are tightened to attach track 1 to a surface, like top surface 32. Specifically, side walls 11 and 12 remain in their original, pre-attachment configuration; and the distance between the upper regions of the walls, that distance forming slot 13, also remains unchanged after attachment. The rigid, non-deformable configuration of track 1, therefore, allows for a consistent, measured opening at slot 13, and, significantly, this configuration provides a solid, non-deformable, unbendable support foundation for maintaining enclosure 40 and all large, substantial and heavy-weight enclosures in position on top surface 32 of bulkhead 30 or similar supporting bulkheads.

Enclosure 40, which can be a vessel, vehicle or other enclosure, comprises lip 42. The shape of lip 42 substantially conforms with interior surface 6 of space 4 of upper section 2. Once track 1 is secured onto bulkhead 30, lip 42 is slid completely through longitudinally extending space 4 of upper section 2. When lip 42 is fully inserted into space 4 of upper section 2, enclosure 40 is advantageously positioned and rigidly secured over and on bulkhead 30, thus successfully enclosing the space of the boat cabin, vehicle, etc.

Since track 1 is secured to bulkhead 30 by means of screws 22 which are located solely within longitudinally extending space 10 of lower section 8, lip 42 of enclosure 40 is able to slide unimpeded and unobstructed through space 4 of upper section 2 of track 1, providing for smooth and easy insertion and removal of the enclosure from the track. In addition, ease of removal and insertion of enclosure 40 is also assisted by the high strength and rigid configuration of track 1. Since track 1 never flexes, bends, or any manner deforms, sliding insertion and removal of lip 42 of enclosure 40 is accomplished most easily and smoothly.

Track 1 can be used on a variety of different bulkheads in which removable enclosures are contemplated. Such uses include, without limitation or restriction, marine enclosures for boat cabins, marine covers, canvas tops, industrial vehicle enclosures, and enclosures for outdoor living spaces such as restaurants and patios, etc. In fact, the location of placement and use of the track of the present invention is not to be considered restricted to the vehicles, vessels, or other locations discussed herein. It is contemplated that the track will be used with any structure where there is a need for an enclosure, cover, or similar protective shelter. In addition, the curvilinear nature bottom surface 18 of track 1 allows it to be mounted on virtually any radiused surface such as on windshields, railings, tubing, and the like.

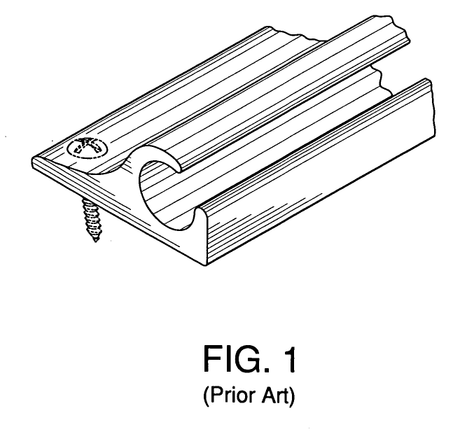

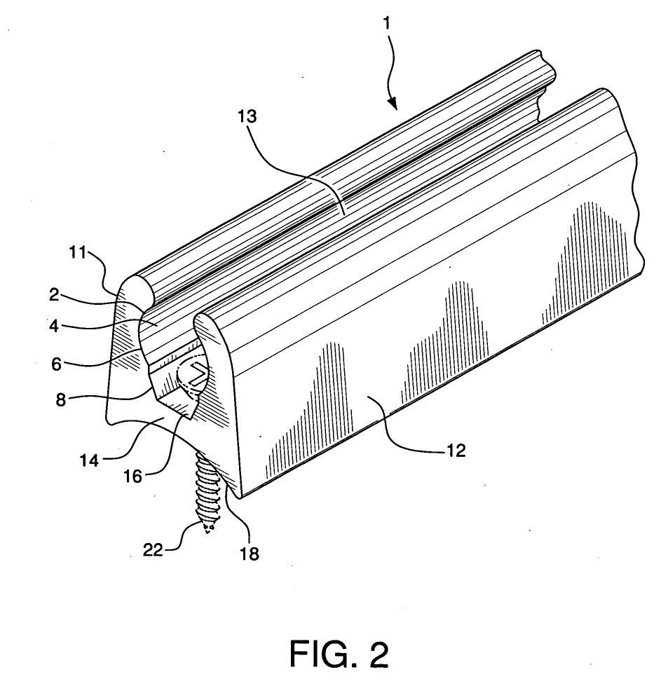

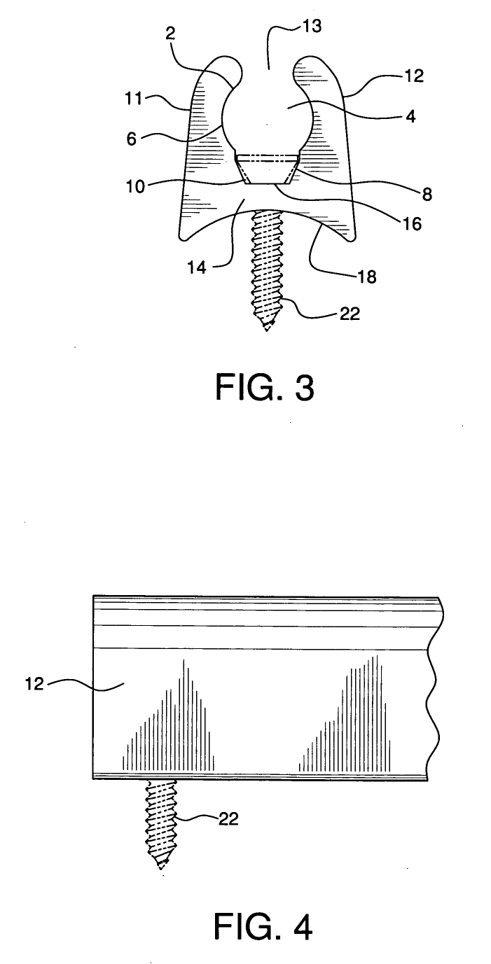

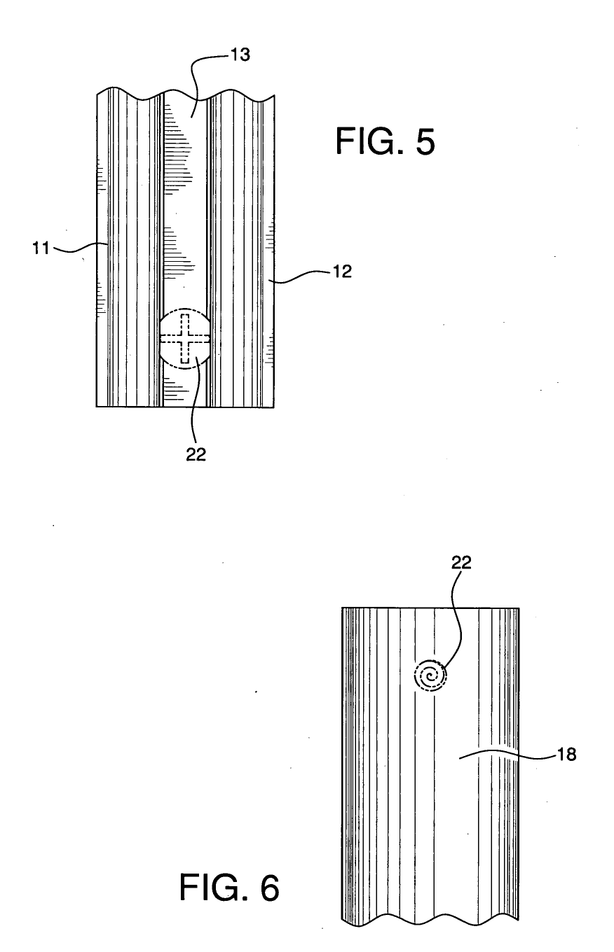

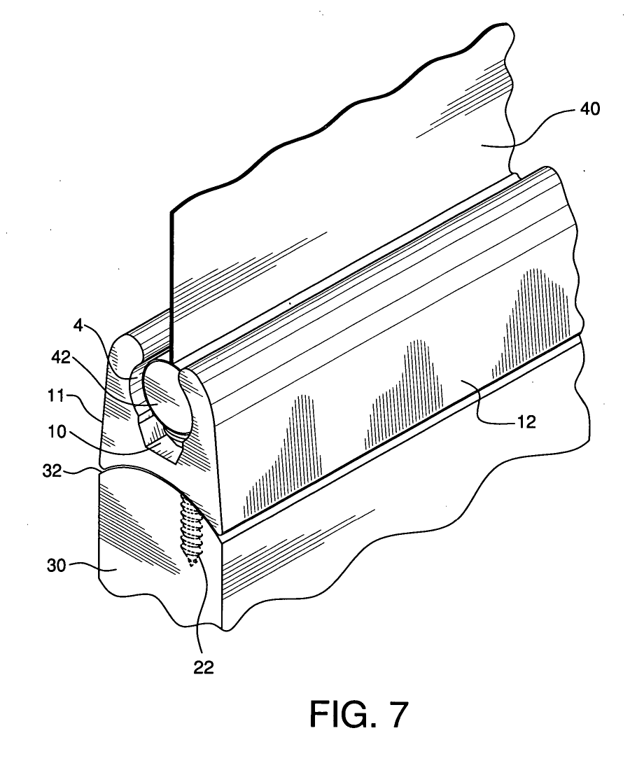

Track 1 of a subject invention replaces the conventional flange style track assembly shown in FIG. 1 and other prior art channel assemblies. Track 1 thus provides an easier, more efficient means of attachment to a bulkhead, using less space and providing a more attractive appearance. Track 1 also allows for unimpeded insertion and removal of enclosures, while requiring the use of less material in its manufacture. The rigid, high strength, non-deformable construction and configuration of track 1 provides a solid and immoveable foundational support for enclosures.

Certain novel features and components of this invention are disclosed in detail in order to make the invention clear in at least one form thereof. However, it is to be clearly understood that the invention as disclosed is not necessarily limited to the exact form and details as disclosed, since is apparent that various modifications and changes may be made without departing from the spirit of the invention.

1. A track for supporting the lip of an enclosure positioned within the track and on the top surface of an upstanding bulkhead, said track comprising:
a rigid, non-deformable elongated unitary body having an upper section and a lower section, said upper section comprising a longitudinally extending space partially surrounded by internal surface means for supporting the lip within the body, said lower section comprising a longitudinally extending space contiguous with the longitudinally extending space of the upper section, and a longitudinally extending bottom wall, the bottom wall having a curvilinear bottom surface conforming to the shape of the top surface of the bulkhead, whereby upon positioning of the track on the top surface and upon insertion of the lip into the space of the upper section, the enclosure is supported on the top surface of the bulkhead; and
means extending through the bottom wall to attach the track to the top surface of the bulkhead, whereby when attached to the top surface, the track at all times does not deform and maintains its rigidity and its pre-attachment configuration.

2. The track as in claim 1 wherein the exterior shape of the lip substantially conforms to the shape of the internal surface means of the upper section.

3. The track as in claim 1 further comprising a longitudinally extending slot opening into the space of the upper surface and rigid side walls extending from the bottom wall to the slot.

4. The track as in claim 3 wherein the slot comprises the distance between the side walls, and when the track is attached to the top surface, the side walls at all times do not deform and maintain their rigidity and pre-attachment configuration and the distance between the side walls at all times, including after attachment of the track to the top surface, remains the same.

5. The track as in claim 1 wherein the means to attach the track is located within the space of the lower section and there is no contact between said means and the lip when the lip is inserted within the space of the upper section.

6. The track as in claim 1 wherein the means to attach the track permits the secure attachment of the track to the top surface while allowing unimpeded insertion of the lip into the space of the upper section.

7. The track as in claim 1 wherein the internal surface is substantially curvilinear.

8. The track as in claim 1 wherein the enclosure is a cover to be used on marine vessels.

9. The track as in claim 1 wherein the enclosure is a cover to be used on industrial vehicles.

10. The track as in claim 1 wherein the enclosure is to be used to enclose living spaces.
